(19) United States
(12) Patent Application Publication
(10) Pub. No.: US 2009/0196596 A1
(43) Pub. Date: Aug. 6, 2009

(54) CAMERA CARRYING DEVICE

(76) Inventor: Andrew Chamberlayne, North Vancouver (CA)

Correspondence Address: CAMERON IP, SUITE 1401 - 1166 ALBERNI STREET, VANCOUVER, BC, V6E 3Z3, CA

(21) Appl. No.: 12/026,016

(22) Filed: Feb. 5, 2008

(51) Int. Cl. G03B 17/00

(52) U.S. Cl. 396/422; 396/420

(57) ABSTRACT

A device for rotatably mounting a camera on a person comprises first and second connecting means. The first connecting means has a U-shaped slot which is defined by a curved pocket and a pair of opposed channels which extend from the pocket. The second connecting means has a circular plate which is slidably received by the U-shaped slot. The circular plate is rotatable within the U-shaped slot. A threaded member extends from one of said first connecting means or said second connecting means. The threaded member is for engaging a threaded female tripod receiver of the camera. A strap assembly is connected to another one of said first connecting means or said second connecting means. The strap assembly is for mounting the device on the person.

### BACKGROUND OF THE INVENTION

The present invention relates to a camera carrying device and, in particular, to a device for rotatably mounting a camera on a person.

Camera carrying devices are well known, the simplest being a strap, secured to a camera, which allows a person to carry the camera around their neck or shoulder. However, the strap allows the camera to swing freely about the person. The camera may therefore become damaged upon impact with the person or another object. The strap may also become entangled with either the camera, the person, or another object and consequently interfere with the person's ability to take a picture. To overcome the above-mentioned shortcomings numerous body-mounted camera cases have been developed. Carrying a camera disposed within a body-mounted camera case removes the need to have a strap secured to the camera. Examples of body-mounted camera cases can be found at www.lowepro.com which is operated, at least in part, by Lowepro USA of Suite 200-1003 Gravenstein Highway North, Sebastopol, Calif., 95472. However, body-mounted camera cases are also limiting. The time required to remove the camera from within the case may prevent a person from taking a desired picture, particularly in situations where the scene is fluid.

U.S. Pat. No. 5,375,749 to Oliva discloses a multi-purpose holster apparatus that may be used to carry a camera, and which offers an alternative to traditional camera straps and cases. The holster apparatus disclosed by Oliva comprises a frame (20) that is received on a belt or a waistband. A sleeve (24) is integrally formed with and protrudes from the frame (20). The sleeve (24) is designed for releasable engagement with an interlocking plate (36). The interlocking plate (36) supports threaded bolt (31) which is designed to fit into a threaded female tripod receiver of a camera. Accordingly, the holster apparatus disclosed by Oliva may be used to carry a camera on the waist. However, it is awkward for a person to carry a larger camera, similar to the type used by a professional photographer, on their waist. Furthermore, it is difficult for a person to operate certain features of a camera since the camera is neither rotatable nor at chest level.

There is therefore a need for an improved camera carrying device.

### SUMMARY OF THE INVENTION

It is an object of the present invention to provide a device for rotatably mounting a camera on a person and, in particular, on a person's chest.

According to one embodiment there is provided a device for rotatably mounting a camera on a person. The device comprises first and second connecting means. The first connecting means has a U-shaped slot which is defined by a curved pocket and a pair of opposed channels which extend from the pocket. The second connecting means has a circular plate which is slidably received by the U-shaped slot. The circular plate is rotatable within the U-shaped slot. A threaded bolt extends from one of said first connecting means or said second connecting means. The threaded bolt is for engaging a threaded female tripod receiver of the camera. A strap assembly is connected to another one of said first connecting means or said second connecting means. The strap assembly is for mounting the device on the person.

More particularly, there is provided a device for rotatably mounting a camera on a person. The device comprises a female connector and a male connector. The female connector has a U-shaped slot defined by a curved pocket and a pair of opposed channels which extend from the pocket. The male connector has a pair of plates which are spaced-apart by a cylindrical body. A first one of the plates is circular and slidably received by the U-shaped slot. The first one of the plates is also rotatable within the U-shaped slot. A second one of the plates has a threaded bolt extending therefrom. The threaded bolt is for engaging a threaded female tripod receiver of the camera. A strap assembly is connected to the female connector. The strap assembly is for mounting the device on the person.

The device disclosed herein provides the advantage of allowing a person to comfortably carry an easily retrievable camera. The device also provides the advantage of allowing a person to operate various features of the camera while carrying the camera in a hands-free manner. For example, the device allows for the changing of telescopic lens and the viewing of a rear screen of a digital camera.

### BRIEF DESCRIPTION OF THE DRAWING

Referring to the drawings:

FIG. 1 is a side perspective view showing a camera rotatably mounted on a person, by a device according to an embodiment of the invention, wherein the camera is in a first position;

FIG. 2 is a side perspective view showing a camera rotatably mounted on a person wherein the camera is in an intermediate position;

FIG. 3 is a side perspective view showing a camera rotatably mounted on a person wherein the camera is in a second position;

FIG. 4 is a front perspective showing a device used to rotatably mount a camera on a person;

FIG. 5 is a perspective view showing a female connector of the device of FIG. 4;

FIG. 6 is a front elevation view of the female connector of FIG. 5;

FIG. 7 is an elevation, cross-sectional view taken down line A-A of FIG. 6;

FIG. 8 is a perspective view showing a male connector of the device of FIG. 4;

FIG. 9 is a side elevation view of the male connector of FIG. 8;

FIG. 10 is an exploded view showing the female connector and the male connector of the device of FIG. 4;

FIG. 11 is a perspective, partially in section view showing the female connector and the male connector of the device of FIG. 4;

FIG. 12 is a perspective view, partially in section, showing the male connector of the device of FIG. 4 engaged with a threaded female tripod receiver of a camera; and

FIG. 13 is a side perspective view showing a camera rotatably mounted on a person wherein the camera is covered by a tarp.

### DETAILED DESCRIPTION OF THE PREFERRED EMBODIMENT

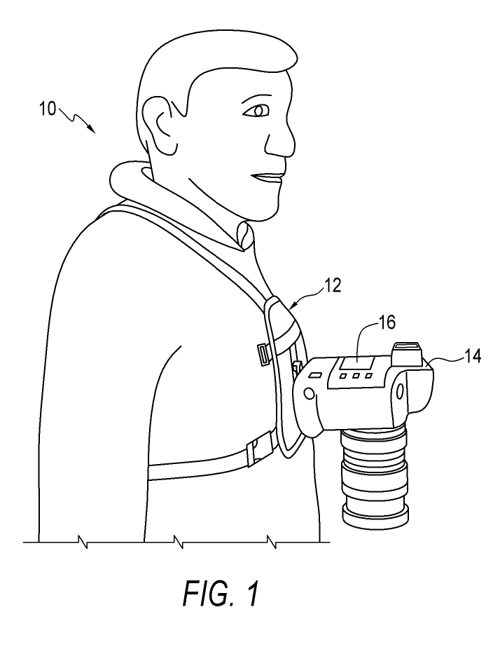

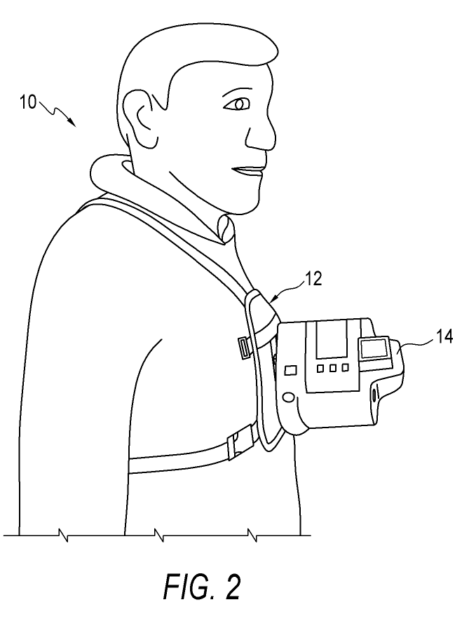

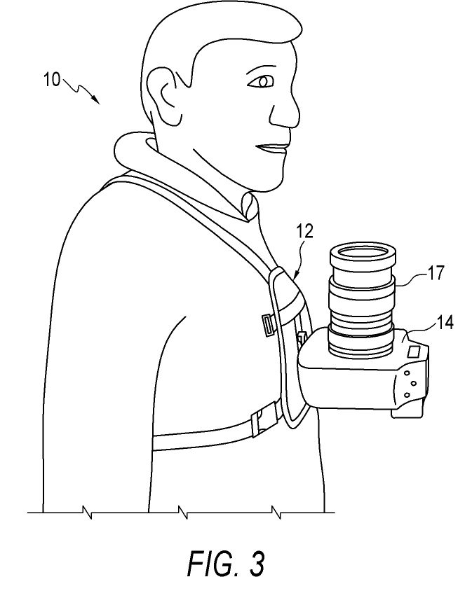

Referring to the drawings, and first to FIGS. 1 to 3, a person 10 is shown wearing a device 12 with a camera 14 rotatably secured thereon. FIG. 1 shows the camera 14 in a first position. In the first position, the camera 14 faces downwardly, allowing the person 10 to view digital photographs, or video, on a screen 16 disposed on a back of the camera 14. FIG. 3 shows the camera 14 in a second position. In the second position, the camera 14 faces upwardly, allowing the person 10 to change a lens 17 disposed on a front of the camera 14. The second position is particularly useful for professional photographers who are often required to change lenses. FIG. 2 shows the camera 14 in an intermediate position as it is rotated between the first and second positions. It will be understood by a person skilled in the art that the terms “downwardly” and “upwardly” are used solely in relation to the position of the camera 14 as shown in FIGS. 1 and 3 respectively. It will further be understood by a person skilled in the art that although the device 12 disclosed herein is particularly useful for carrying a digital camera, other forms of equipment may be carried using the device 12.

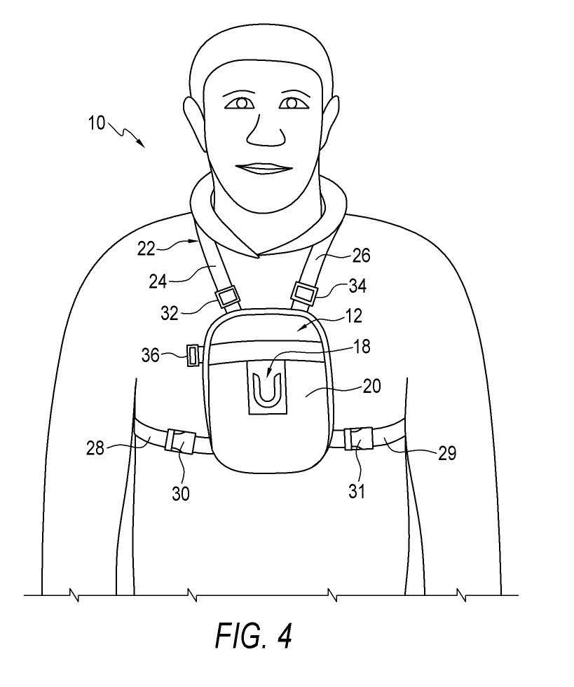

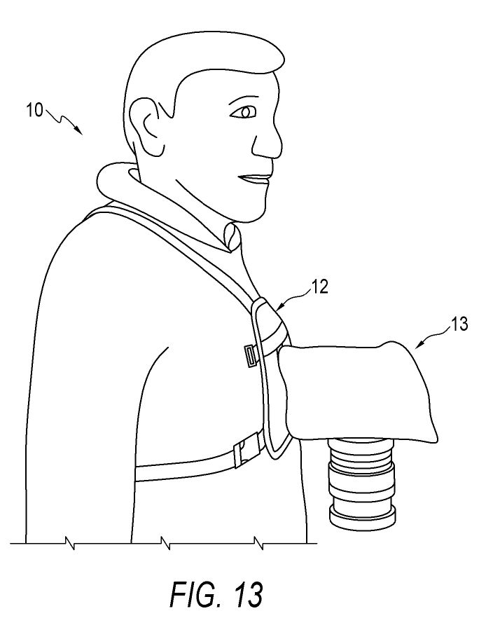

Referring now to FIG. 4, the person 10 is shown wearing the device 12 without the camera 14 secured thereto. The device 12 comprises a first connecting means, in the form of a female connector 18, which is mounted on the person's chest. In this example, the female connector 18 is disposed within a fabric jacket 20 although this is not a requirement. The female connector 18 and the fabric jacket 20 are mounted on the person 10 using a strap assembly 22. The strap assembly 22 comprises securing and adjusting means for securing and adjusting straps 24, 26, 28, and 29 about the person. In this example, the securing and adjusting means comprise buckles 30 and 31 and tension straps 32 and 34. However, any suitable form of fastener may be used. Means for allowing additional equipment to be connected to the device 12, for example a tension strap 36 as shown in FIG. 4, may also be provided on either the fabric jacket 20 or any one of the straps 24, 26, 28, and 29. FIG. 13 shows a tarp 13 attached to the fabric jacket 20. The tarp 13 may be used to cover the camera 14 to protect it from rain, snow, or other elements.

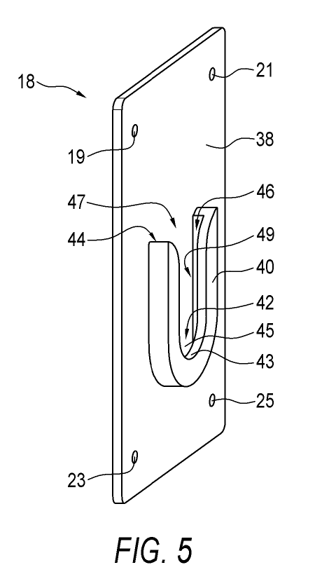

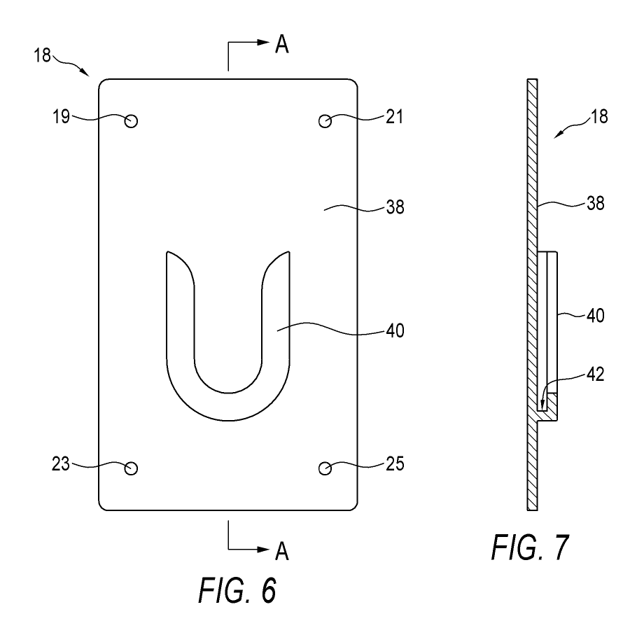

The female connector 18, which is shown in greater detail in FIGS. 5 to 7, includes a plate 38 and a hollow U-shaped protrusion 40. The U-shaped protrusion is integrally formed with and protrudes from the plate 38. In this example, the plate 38 is generally rectangular and has apertures 19, 21, 23, and 25 near each corner thereof The apertures 19, 21, 23, and 25 provide means to connect the female connector 18 to the fabric jacket 20. Alternatively, in another embodiment, the apertures 19, 21, 23, and 25 may be used to connect the female connector 18 directly to the strap assembly 22.

As best shown in FIG. 5, the plate 38 and the U-shaped protrusion 40 define a generally curved pocket 42 and a pair of opposed channels 44 and 46 which extend from the pocket 42. The pocket 42 and the channels 44 and 46 define a U-shaped receptacle, or U-shaped slot 49, which may slidably receive a plate through an opening 47 disposed between the channels 44 and 46. There is a lip 43 at a mouth 45 of the pocket 42.

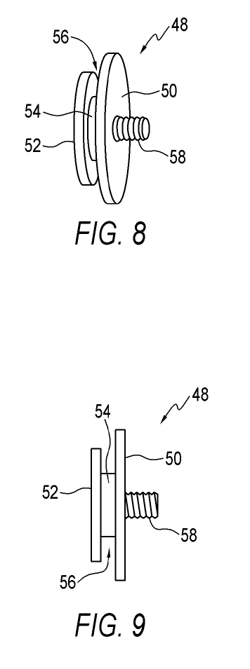

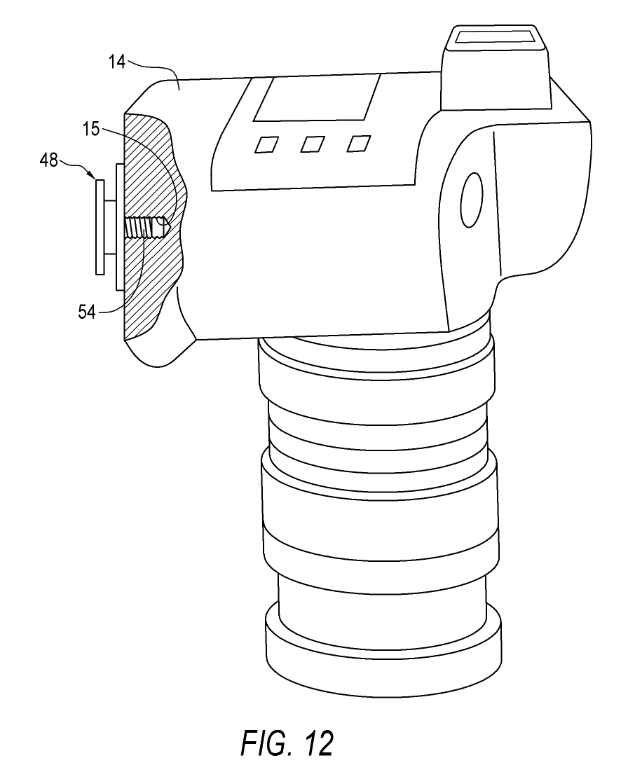

Referring now to FIGS. 8 and 9, a second connecting means of the device 12, in the form male connecter 48, is shown in greater detail. The male connector 48 includes a pair of circular plates 50 and 52 which are spaced-apart by a cylindrical body 54. The cylindrical body 54 has a smaller diameter than the plates 50 and 52, and defines an annular recess 56 between the plates 50 and 52. In this example, the plates 50 and 52 differ in diameter although this is not a requirement. A threaded member 58 extends outwardly from the male connector 48. The threaded member 58 is designed to engage a threaded female tripod receiver 15 of the camera 14 as best shown in FIG. 12. The plates 50 and 52 may also be grooved (not shown) along their circumferences to assist a person in gripping the male connector 48 when screwing the threaded member 58 into the female tripod receiver 15 of the camera 14.

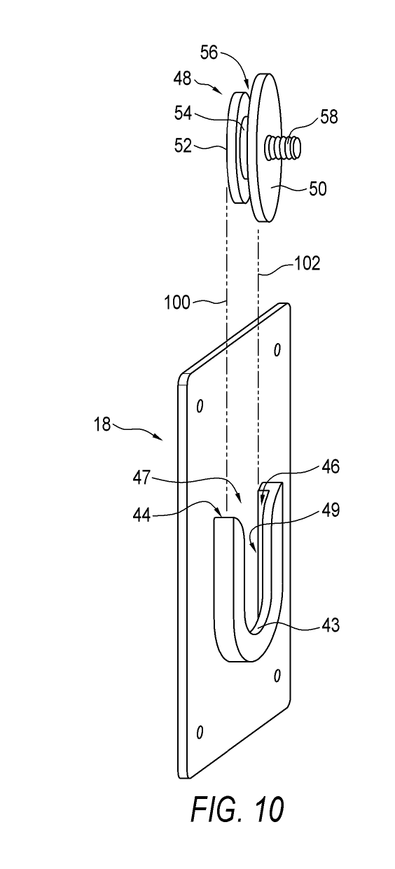

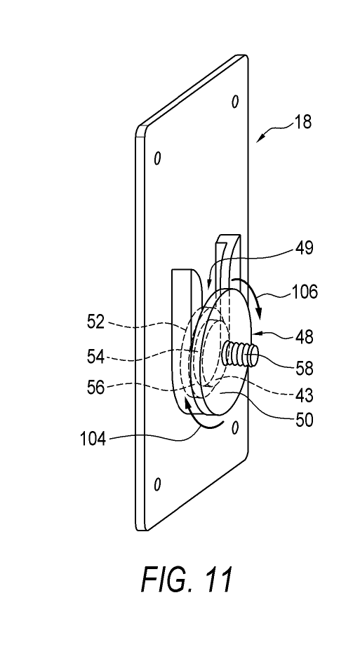

As best shown in FIGS. 10 and 11, the U-shape of the slot 49 of the female connector 18 and the generally annular shape of the male connector 48 allow the male connector 48 to be rotatably received by the female connector 18. Referring to FIG. 10, in particular, a first one of the plates 52 of the male connector 40 is slidably received by the U-shaped slot 49 of the female connector 18. Said first one of the plates 52 is received though the opening 47 between the channels 44 and 46 as indicated by broken lines 100 and 102. As best shown in FIG. 11, when said first one of the plates 52 of the male connector 48 is received by the slot 49 of the female connector 18, the cylindrical body 54 of the male connector 48 rests on the lip 43 of the pocket 42, shown in FIG. 5, of the female connector 18. The annular recess 56 of the male connector 18 engages the lip 43 of the pocket 42 of the female connector 18. Accordingly, the plates 50 and 52 of male connector 48 are on opposite sides of the slot 49 of the female connector 18. This prevents accidental decoupling of the male connector 48 and the female connector 18 while still allowing the male connector 48 to rotated bi-directionally relative to the female connector 18 as indicated generally by arrows 104 and 106.

In operation, the threaded member 58 of the male connector 48 is engaged with the threaded female tripod receiver 15 of the camera 14 as shown in FIG. 12. The male connector 48 can then be coupled, as described above, to the female connector 18 which is mounted on the person 10 by the strap assembly 22 as shown in FIG. 3. This allows the person 10 to carry the camera 14 in a hands-free manner, at chest level, as shown in FIGS. 1 to 3. The camera 14 can be rapidly and easily removed from the device 12 because the male connector 48 is simply slidably received by the female connector 18. Furthermore, because the male connector 48 is rotatably coupled to the female connector 18, the carried camera 14 can be rotated between the first position shown in FIG. 1 and the second position shown in FIG. 3. This provides the advantage of allowing the person 10 to view digital photographs, or video, on the camera screen 16 disposed on the carried camera 14 and change the lens 18 of the carried camera.

It will be understood by a person skilled in the art that although in this example the male connector is secured to the camera and the female connector is mounted on the person's chest that in other examples a male connector may be secured to the camera and a female connector may be mounted on the person's chest. Alternatively, any suitable means to rotatably mount the camera may be used. For example, in another embodiment, the plates of the male connector may be rotatably connected to each other allowing for a squared plate to be received by the female connector while still allowing for rotation of the mounted camera.

It will further be understood by someone skilled in the art that many of the details provided above are by way of example only and are not intended to limit the scope of the invention which is to be determined with reference to the following claims.

What is claimed is:

1. A device for rotatably mounting a camera on a person, the camera having a threaded female tripod receiver, and the device comprising:
a first connecting means having a U-shaped slot defined by a curved pocket and a pair of opposed channels which extend from the pocket;
a second connecting means having a plate, the plate being slidably received by the U-shaped slot of the first connecting means, and the plate being rotatable within the U-shaped slot of the first connecting means;
a threaded member extending from one of said first connecting means or said second connecting means, the threaded member being for engaging the threaded female tripod receiver of the camera; and
a strap assembly connected to another one of said first connecting means or said second connecting means, the strap assembly being for mounting the device to the person.

2. The device as claimed in claim 1 wherein the strap assembly is connected to the first connecting means.

3. The device as claimed in claim 2 wherein the first connecting means is disposed within a jacket.

4. The device as claimed in claim 3 wherein the jacket includes means for allowing additional equipment to be connected to the device.

5. The device as claimed in claim 1 wherein the strap assembly includes means for allowing additional equipment to be connected to the device.

6. The device as claimed in claim 1 wherein the first connecting means is defined by a plate and a U-shaped protrusion, the U-shaped protrusion being integral with and protruding from the plate.

7. The device as claimed in claim 1 wherein the threaded member extends from the second connecting means.

8. The device as claimed in claim 1 wherein the plate is a circular plate.

9. The device as claimed in claim 8 wherein the second connecting means further includes another plate which is spaced-apart from the circular plate by a cylindrical body, the threaded member extending from said another plate which is spaced-apart from the circular plate.

10. The device as claimed in claim 9 further including grooves about the circumference of the circular plate.

11. The device as claimed in claim 1 wherein the strap assembly further includes a tarp for covering the camera.

12. A device for rotatably mounting a camera on a person, the camera having a threaded female tripod receiver, and the device comprising:
a female connector having a U-shaped slot defined by a curved pocket and a pair of opposed channels which extend from the pocket;
a male connector having a pair of plates which are spaced-apart by a cylindrical body, a first one of the plates being circular and slidably received by the U-shaped slot of the female connector, the first one of the plates being rotatable within the U-shaped slot of the female connector, and a second one of the plates having a threaded member extending therefrom, the threaded member being for engaging the threaded female tripod receiver of the camera; and
a strap assembly connected to the female connector, the strap assembly being for mounting the device to the person's body.

13. The device as claimed in claim 12 wherein the female connector is disposed within a jacket.

14. The device as claimed in claim 12 wherein the jacket includes means for allowing additional equipment to be connected to the device.

15. The device as claimed in claim 12 wherein the strap assembly includes means for allowing additional equipment to be connected to the device.

16. The device as claimed in claim 12 wherein the female connector is defined by a plate and a U-shaped protrusion, the U-shaped protrusion being integral with and protruding from the plate.

17. The device as claimed in claim 12 wherein at least one of the circular plate has grooves about its circumference.

18. A camera and a device for mounting the camera on a person:
the camera having a threaded female tripod receiver; and
the device comprising;
a first connecting means having a U-shaped slot defined by a curved pocket and a pair of opposed channels extending from the pocket;
a second connecting means having a circular plate, the circular plate being slidably received by the U-shaped slot of the first connecting means, and the circular plate being rotatable within the U-shaped slot of the first connecting means thereby allowing the camera to be rotated between a first position and a second position;
a threaded member extending from one of said first connecting means or said second connecting means, the threaded member being for engaging the threaded female tripod receiver of the camera; and
a strap assembly connected to another one of said first connecting means or said second connecting means, the strap assembly being for mounting the device to the person.
